(19) United States
(12) Patent Application Publication
(10) Pub. No.: US 2026/0282052 A1
(43) Pub. Date: Sep. 17, 2026

(54) BROADCAST TRANSMISSION POWER MODIFICATION BASED ON ADVERTISEMENT PACKET FEEDBACK

(71) Applicant: GOOGLE LLC, Mountain View, CA (US)

(72) Inventors: Li-Xuan Chuo, San Jose, CA (US); Qi Jiang, San Jose, CA (US); Praveen Kumar Rayasamudra Vijayakumar, Sunnyvale, CA (US)

(21) Appl. No.: 19/080,026

(22) Filed: Mar. 14, 2025

(51) Int. Cl. H04W 72/30; H04W 48/10; H04W 72/044

(52) U.S. Cl. CPC H04W 72/30; H04W 48/10; H04W 72/0473

(57) ABSTRACT

A user equipment (UE) broadcasts packets of an audio stream on isochronous channels based on a transmission power profile. Concurrently with broadcasting these packets, the UE listens for advertisement packets each indicating corresponding link quality data from a receiver device subscribed to the audio stream. Using the link quality data from the advertisement packets, the UE determines a respective link quality over a moving period of time between the UE and the receiver devices subscribed to the audio stream. The UE then selects an updated transmission power profile based on the determined link qualities.

### BACKGROUND

Some user equipment (UE) is configured to concurrently provide an audio stream to two or more receiver devices, such as earbuds, headphones, speakers, and the like, by broadcasting packets of the audio stream on one or more isochronous channels. These broadcast packets of the audio stream are then receivable by any number of receiver devices within the broadcast range. However, because the packets of the audio stream are broadcast rather than sent over an established connection, the UE is unable to receive data from the receiver devices subscribed to the broadcast and cannot modify the transmission power of the broadcast based on the needs of the subscribed receiver devices. As such, the UE broadcasts the audio stream over the isochronous channels at a fixed maximum transmission power to ensure that the subscribed receiver devices receive the audio stream. However, broadcasting the audio stream at a fixed maximum transmission power results in high power consumption and quickly drains the battery of the UE. Further, broadcasting the audio stream at a fixed maximum transmission power increases the likelihood of jamming other broadcasts in a surrounding area which limits the ability of receiver devices to receive broadcast signals from any UE.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a user equipment (UE) broadcast framework configured to adjust a transmission power profile based on advertisement packets from one or more receiver devices, in accordance with some embodiments.

FIG. 2 is a flow diagram of an example operation for modifying a transmission power profile based on link quality data of receiver devices within a tracking window, in accordance with some embodiments.

FIG. 3 is a flow diagram of an example method for adjusting a transmission power profile for a broadcast based on advertisement packets from one or more receiver devices, in accordance with some embodiments.

### DETAILED DESCRIPTION

Systems and techniques disclosed herein include user equipment (UE), such as compute-enabled phones (i.e., smartphones), tablet computers, personal computers, compute-enabled wearable devices, Internet of Things (IoT) devices, laptop computer, routers, mobile hotspot devices, automotive devices, manufacturing devices, and the like, configured to broadcast an audio stream such that multiple receiver devices within the range of the broadcast receive the audio stream. To broadcast the audio stream, a UE uses one or more isochronous channels to broadcast packets of the audio stream based on one or more certain communication protocols, for example, Bluetooth® Low Energy communication protocol (Bluetooth LE), so that the packets of the audio stream are receivable within a certain range (e.g., the distance from the UE at which packets broadcast by the UE are receivable by a receiver device). Further, the UE broadcast is configured to broadcast these packets on the isochronous channels based on a transmission power profile that indicates, for example, a maximum transmission power, a minimum transmission power, a power allocation type (e.g., intelligent power allocation, even power allocation), or any combination thereof. As an example, the UE is configured to broadcast each isochronous channel at the same transmission power (e.g., maximum transmission power) based on a transmission power profile indicating the maximum transmission power and an even power allocation type. As another example, the UE is configured to broadcast one or more isochronous channels at different power levels (e.g., up to a maximum transmission power) based on a transmission power profile indicating the maximum transmission power and an intelligent power allocation type.

In response to receiving one or more packets of the audio stream broadcast by the UE, a receiver device is configured to output the audio in the received packets. Such receiver devices, for example, include portable devices having one or more output devices (e.g., speakers) such as wireless headphones, wireless earbuds, wireless in-ear monitors, wireless over-ear headphones, wireless on-ear headphones, bone-conduction headphones, wireless speakers, wireless hearing aids, and the like. Further, in response to receiving one or more packets of the broadcast audio stream, a receiver device is configured to begin periodically broadcasting (e.g., every second) an advertisement packet indicating link status data associated with the received audio stream. Such link status data includes, for example, how choppy the received audio stream is for a corresponding receiver device, a packet error rate (PER) for a corresponding receiver device, the number of times a corresponding receiver device was out of sync with the broadcast audio stream, or any combination thereof, to name a few. Additionally, in response to broadcasting one or more packets of the audio stream, the UE is configured to periodically listen for advertisement signals broadcast by any receiver device. From these received advertisement signals, the UE identifies the receiver devices that are actively receiving the broadcast audio stream (e.g., subscribed to the audio stream). For example, in response to detecting an advertisement packet indicating that the advertisement signal includes link status data, the UE determines that the receiver device identified in the advertisement packet is actively receiving the broadcast audio stream and adds data representing the receiver device to a list of receiver devices current receiving subscribed to the audio stream (e.g., a broadcast subscriber list).

For each receiver device identified in this list (e.g., for each subscribed receiver device), the UE determines a link quality score, received signal strength indication (RSSI), or both that represents the link quality between the UE and the subscribed receiver device over a tracking window. This tracking window, for example, represents a predetermined moving period of time over which the link quality between the UE and a subscribed receiver device is to be determined. As an example, for each subscribed receiver device, the UE determines a link quality score and RSSI over the period of time indicated by a tracking window based on the PER and transmit power level indicated in the advertisement packets of the subscribed receiver device received during the period of time indicated by a tracking window. After determining a link quality score and RSSI over the tracking window for the receiver devices identified in the broadcast subscriber list (e.g., subscribed receiver devices), the UE selects an updated transmission power profile based on a comparison of these link quality scores and RSSIs to one or more thresholds (e.g., link quality thresholds, RSSI thresholds). For example, the UE selects a low transmission power profile (e.g., medium maximum transmission power, intelligent power allocation type), medium transmission power profile (e.g., high maximum transmission power, intelligent power allocation type), or high transmission power profile (e.g., high maximum transmission power, even power allocation type) based on a comparison of the link quality scores and RSSIs over the tracking window of the subscribed receiver devices to one or more thresholds. After selecting an updated transmission power profile, the UE then begins broadcasting the packets of the audio stream on one or more isochronous channels based on the updated transmission power profile. As an example, the UE broadcasts packets on one or more isochronous channels at one or more transmission powers as indicated by the updated transmission power profile.

In this way, the UE is configured to adjust the transmission power at which the UE broadcasts packets of the audio stream based on the link qualities between the UE and the subscribed receiver devices over the tracking window. That is to say, because the receiver devices are configured to begin broadcasting an advertisement signal including link status data in response to receiving the audio stream, the UE is enabled to receive data indicating the link statuses of the receiver devices even though there is no direct connection between the UE and receiver devices. Further, due to the UE being enabled to receive this link status data from the receiver devices, the UE is able to select a transmission power profile based on the link qualities of these subscribed receiver devices over a tracking window so as to help improve the reception of the audio stream by the subscribed receiver devices. By adjusting the transmission power profile using link qualities of the subscribed receiver devices over a tracking window rather than immediately (e.g., each time an advertisement packet is received), the UE is configured to account for the time needed for the receiver devices to broadcast advertisement packets that include link status data.

As used herein, the term “circuitry” includes hardwired circuitry, programmable circuitry, or a combination thereof. For example, circuitry may include circuitry of an application-specific integrated circuit (ASIC) that is hardwired or hardcoded to perform corresponding functions, one or more processors that execute software stored in one or more memories or other storage media to perform corresponding functions, programmable logic that has been programmed to perform corresponding functions, or some combination thereof.

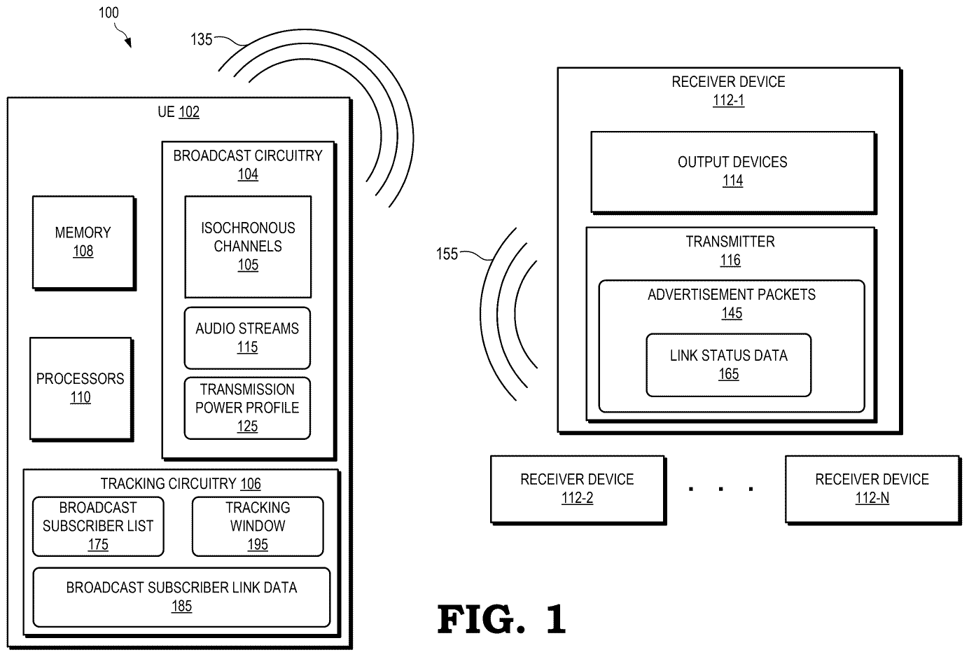

Referring now to FIG. 1, a block diagram of a UE broadcast framework 100 configured to adjust a transmission power profile based on advertisement packets from one or more receiver devices based on advertisement packets from one or more receiver devices is presented, in accordance with some embodiments. In embodiments, UE broadcast framework 100 includes UE 102 configured to broadcast an audio stream 115 such that one or more packets of the broadcast audio stream (represented in FIG. 1 as broadcast audio stream 135) are received by one or more receiver devices 112 within the range of the broadcast (e.g., the distance from UE in which one or more packets of the broadcast audio stream 135 are receivable). UE 102, for example, includes a smartphone, tablet computer, personal computer, laptop computer, compute-enabled wearable device (e.g., smartwatch, fitness tracker, smart bracelet), IoT device, router, mobile hotspot device, an automotive device, a manufacturing device, or any combination thereof, to name a few. Additionally, an audio stream 115 includes one or more packets that include data representing audio to be output by one or more receiver devices 112.

To broadcast an audio stream 115, UE 102 includes broadcast circuitry 104 configured to broadcast one or more packets of the audio stream 115 using one or more isochronous channels 105 (e.g., broadcast isochronous channels). As an example, broadcast circuitry 104 includes one or more isochronous channels 105 over which broadcast circuitry 104 broadcasts packets of an audio stream 115 based on one or more communication protocols (e.g., a Bluetooth low energy communication protocol). An isochronous channel 105 is configured to broadcast one or packets of an audio stream 115 using a corresponding range of frequencies (e.g., 2 MHz range of frequencies) such that the broadcast packets are receivable by receiver devices 112 within the range of the broadcast. According to embodiments, broadcast circuitry 104 is configured to broadcast one or more packets of an audio stream 115 based on a transmission power profile 125 indicating transmit powers (e.g., in decibel-milliwatts (dBm)) for corresponding isochronous channels 105 when broadcasting the audio stream 115. As an example, the transmission power profile 125, for example, includes data indicating a maximum power (e.g., in dBm) at which packets may be broadcast and a power allocation type (e.g., intelligent power allocation, even power allocation, or the like) that indicates how a transmission power is to be determined for corresponding isochronous channels 105 when broadcasting packets of the audio stream 115.

In embodiments, a receiver device 112 configured to receive a broadcast audio stream 115 includes, for example, a portable device configured to receive packets of a broadcast audio stream 135 using one or more communication protocols (e.g., Bluetooth LE) and to output audio represented by the received packets. For example, a receiver device 112 includes one or more wireless headphones, wireless earbuds, wireless in-ear monitors, wireless over-ear headphones, wireless on-ear headphones, bone-conduction headphones, wireless speakers, wireless hearing aids, and the like. In some embodiments, a receiver device 112 includes a paired device (e.g., one device of a pair of devices), such as one earbud of a pair of earbuds, while in other embodiments, a receiver device includes a singular device such as headphones. In response to receiving one or more packets of a broadcast audio stream 135, a receiver device 112 is configured to output the audio represented by the received packets using one or output devices 114 that include, for example, speakers, audio monitors, or the like. Though the example embodiment presented in FIG. 1 shows three receiver devices (112-1, 112-2, 112-N) representing an N integer number (where N>0) of receiver devices as receiving at least a portion of broadcast audio stream 135 (e.g., being within the broadcast range of UE 102), in other embodiments, any non-zero integer number of receiver devices receiving at least a portion of broadcast audio stream 135.

According to embodiments, one more receiver devices 112 are configured to periodically (e.g., every 500 milliseconds, every one second) broadcast one or more advertisement packets 145 including link status data 165 in response to receiving one or more packets of broadcast audio stream 135. This link status data 165 indicates the strength of the link between the receiver device 112 and UE 102 (e.g., the UE 102 that broadcast the audio stream 115). That is to say, the link status data 165 indicates how well the receiver device 112 is receiving packets of the broadcast audio stream 135. For example, link status data 165 includes a PER for the receiver device 112 over a predetermined period of time (e.g., the period of time between broadcasts of advertisement packets 145), the number of times the receiver device 112 was out of sync with the broadcast audio stream 135 over a predetermined period of time, or any combination thereof, to name a few. Further, an advertisement packet 145 broadcast by a receiver device 112 in response to receiving a packet of audio stream 115 includes data indicating that the receiver device 112 is subscribed to the broadcast of the audio stream 115 (e.g., an identifier indicating that the advertisement packet 145 includes link status data 165) an identifier of the receiver device 112 (e.g., a broadcast ID of the receiver device 112), link status data 116 over a predetermined period of time (e.g., one second), or any combination thereof. An advertisement packet 145 broadcast by a receiver device is represented in FIG. 1 as a broadcast advertisement packet 155.

After broadcasting one or more packets of audio stream 115, tracking circuitry 106 of UE 102 periodically listens for advertisement packets 145 broadcast by one or more receiver devices 112 (e.g., listens for broadcast advertisement packets 155). For example, UE 102 listens for broadcast advertisement packets 155 each time a predetermined period of time (e.g., one second) elapses. In response to detecting a broadcast advertisement packet 155, tracking circuitry 106 determines the receiver device 112 associated with the broadcast advertisement packet 155. As an example, tracking circuitry 106 identifies the receiver device 112 based on the identifier for the receiver device 112 (e.g., broadcast ID) indicated in the broadcast advertisement packet 155. After identifying the receiver device 112 associated with the detected broadcast advertisement packet 155, tracking circuitry 106 adds data identifying the receiver device 112 (e.g., a broadcast ID of the receiver device 112) to a broadcast subscriber list 175. This broadcast subscriber list 175, for example, includes data identifying the receiver devices 112 that are currently subscribed to (e.g., receiving one or more packets of) the broadcast audio stream 135. In embodiments, for one or more subscribed receiver devices 112 (e.g., receiver devices 112 identified in the broadcast subscriber list 175) tracking circuitry 106 is configured to generate respective broadcast subscriber link data 185 based on the link status data 165, transmit power, or both indicated in a received broadcast advertisement packets 155 associated with a corresponding receiver device 112. This broadcast subscriber link data 185 includes data representing the strength of the link between the UE 102 and a corresponding subscribed receiver device 112 such as one or more PERs, RSSIs, or both.

From the broadcast subscriber link data 185 for a subscribed receiver device 112, tracking circuitry 106 is configured to determine a link quality score and an average RSSI over a tracking window 195 that indicates a moving period of time (e.g., a period of time relative to the current time). For example, tracking window 195 includes a moving period of time that captures the broadcast of one or more advertisement packets 145 from the subscribed receiver devices 112 (e.g., a moving a period of time including one or more advertisement periods of the subscribed receiver devices 112). In embodiments, tracking circuitry 106 determines a link quality score and average RSSI for a subscribed receiver device 112 over the period of time indicated by the tracking window 195 based on broadcast subscriber link data 185 generated from broadcast advertisement packets 155 received from the subscriber receiver device 112 during the period of time indicated by the tracking window (e.g., based on from broadcast advertisement packets 155 received from the subscriber receiver device 112 during the period of time indicated by the tracking window). Tracking circuitry 106, according to embodiments, determines a link quality score representing the link quality between UE 102 and a subscriber receiver device 112 over a tracking window 195 based on the PERs indicated in the link status data 165 of broadcast advertisement packets 155 received from the receiver device 112 during the tracking window 195. Further, tracking circuitry 106 determines an average RSSI of a subscribed receiver device 112 over a tracking window 195 based on the transmit power indicated by broadcast advertisement packets 155 received from the subscribed receiver device 112 during the tracking window 195.

Using the determined link quality scores and average RSSIs for the subscribed receiver devices 112, tracking circuitry 106 selects a predetermined updated transmission power profile indicating a maximum power (e.g., in dBm) at which packets may be broadcast and a power allocation that indicates how a transmission power is to be determined for corresponding isochronous channels 105 when broadcasting the audio stream 115. According to embodiments, tracking circuitry 106 selects a corresponding predetermined updated transmission power profile based on a comparison of the link quality scores and average RSSIs for the subscribed receiver devices 112 to one or more thresholds (e.g., link quality thresholds, RSSI thresholds). As an example, in response to a link quality score over the tracking window 195 of one or more subscribed receiver devices 112 being less than a threshold and in response to an average RSSI over the tracking window 195 of one or more subscribed receiver devices 112 being less than a threshold, tracking circuitry 106 determines that there is a poor link quality between the UE 102 and one or more subscribed receiver devices 112 and selects a predetermined updated transmission power profile indicating a high maximum transmit power (e.g., highest allowed maximum transmit power) and an even power allocation. After selecting the updated transmission power profile, tracking circuitry 106 updates transmission power profile 125 based on the selected updated transmission power profile (e.g., to match the selected updated transmission power profile). Broadcast circuitry 104 then broadcasts one or more packets (e.g., one or more additional packets) of the audio stream 115 on the isochronous channels 105 based on the updated transmission power profile (e.g., at transmission powers based on the updated transmission power profile).

In embodiments, UE 102 includes a memory 108 that includes a storage, random-access memory (RAM) (e.g., static RAM, dynamic RAM), or both storing executable instructions, data, or both used by broadcast circuitry 104, tracking circuitry 106, or both to broadcast one or more audio streams 115, listen for one or more broadcast advertisement packets 155, update a broadcast subscriber list 175, determine broadcast subscriber data 185, update transmission power profile 125, or any combination thereof, to name a few. Further, in some embodiments, memory 108 stores executable instructions that, when executed by one or more processors 110 (e.g., central processing units, graphics processing units, microprocessors) of UE 102, cause the processors 110 to broadcast one or more audio streams 115, listen for one or more broadcast advertisement packets 155, update a broadcast subscriber list 175, determine broadcast subscriber data 185, update transmission power profile 125, or any combination thereof, to name a few. Additionally, one or more processors 110, in some embodiments, implement at least a portion of broadcast circuitry 104, tracking circuitry 106, or both.

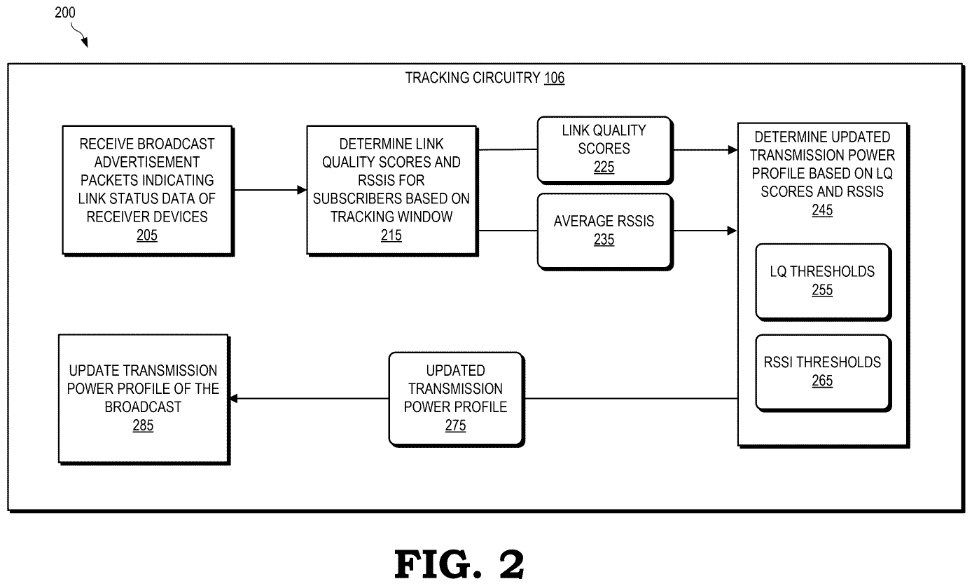

Referring now to FIG. 2, example operation 200 for modifying a transmission power profile based on link quality data within a tracking window is presented, in accordance with embodiments. In embodiments, example operation 200 is implemented at least in part by tracking circuitry 106 of UE 102. Example operation 200 includes, at block 205, tracking circuitry 106 periodically listening for (e.g., every one second) and receiving broadcast advertisement packets 155 from one or more receiver devices 112 receiving at least a portion of broadcast audio stream 135. In response to receiving a broadcast advertisement packet 155, tracking circuitry 106 identifies the receiver device 112 indicated in the broadcast advertisement packet 155 (e.g., by a device ID) and adds data representing the receiver device 112 to the broadcast subscriber list 175. Additionally, tracking circuitry 106 determines broadcast subscriber link data 185 for the receiver device 112 based on the link status data 165 indicated in the received broadcast advertisement packet 155. As an example, tracking circuitry 106 determines a PER and RSSI for the receiver device 112. For the receiver devices 112 indicated in the broadcast subscriber list 175 (e.g., for the subscribed receiver devices 112), tracking circuitry 106, at block 215, determines respective link qualities between the UE and the subscribed receiver device 112 based on link status data 165 indicated in the received broadcast advertisement packets 155, broadcast subscriber link data 185, or both. As an example, tracking circuitry 106 is configured to determine respective link quality scores 225 and average RSSIs 235 for the receiver devices 112 over a tracking window 195 (e.g., over the period of time indicated in the tracking window 195) based on link status data 165 indicated in the received broadcast advertisement packets 155, broadcast subscriber link data 185, or both. According to embodiments, tracking circuitry 106 determines respective link quality scores 225 and average RSSIs 235 over a five second period as indicated by the tracking window 195.

In embodiments, tracking circuitry 106 determines a link quality score 225 for a subscribed receiver device 112 within a tracking window 195 based on the PERs of the subscribed receiver device 112 indicated in broadcast advertisement packets 155 from the subscribed receiver device 112 received within the tracking window 195 (e.g., based on the PERs of the subscribed receiver device 112 within the tracking window 195). For example, tracking circuitry 106 is configured to determine a link quality score 225 for a subscribed receiver device 112 over a tracking window 195 by using the following equations:

$$Ema\_TX {\_PKT}_{persec} = \frac{\begin{matrix}( ( 1 - {PER}_{persec} ) * {TX\_PKT}_{persec} * \\ ( Window - 1 ) + Ema\_TX \_PKT )\end{matrix}}{Window} \qquad [ EQ 1 ]$$

$$Link Quality Score = \frac{255 * Ema\_TX {\_PKT}_{persec}}{{TX\_PKT}_{persec}} \qquad [ EQ 2 ]$$

wherein Ema_TX_PKT_{persec} represents the average number of packets of the audio stream 115 per second received by the subscribed receiver device 112 over the tracking window 195, PER_{persec} represents the corresponding average PER per second (e.g., average packet error rate per second) of the subscribed receiver device 112 over the tracking window 195, TX_PKT_{persec} represents the total number of packets of the audio stream 115 broadcast per second by UE 102 over the tracking window 195, Window represents the period of time indicated by the tracking window 195, and Ema_TX_PKT represents the number of packets of the audio stream 115 received by the subscribed receiver device 112 during the most recent advertising period of the subscribed receiver device 112 (e.g., the period of time between when a previous (e.g., immediately previous) and most recent advertisement packet 145 was broadcast by the subscribed receiver device 112). In this way, the link quality score 225 represents the strength of the link between UE 102 and the subscribed receiver device 112 over the tracking window 195. Further, tracking circuitry 106 is configured to determine an average RSSI for a subscribed receiver device 112 (e.g., represented in FIG. 2 as average RSSI 235) based on the transmit powers indicated in the broadcast advertisement packets 155 received from the subscribed receiver device 112 within the tracking window 195.

At block 245, tracking circuitry 106 is configured to select a predetermined updated transmission power profile 275 based on a comparison of the link quality scores 225 and average RSSIs 235 of the subscribed receiver devices 112 to one or more link quality thresholds 255, RSSI thresholds 265, or both. For example, tracking circuitry 106 is configured to select an updated transmission power profile 275 (e.g., low TX power profile) indicating a medium (e.g., below power limit or maximum allowed power) maximum transmission power and an intelligent power allocation based on one or more link quality scores 225 of the subscribed receiver devices 112 being equal to or above one or more link quality thresholds 255 and one or more average RSSIs 235 of the subscribed receiver devices 112 being equal to or above one or more RSSI thresholds 265. As another example, tracking circuitry 106 is configured to select an updated transmission power profile 275 (e.g., medium TX power profile) indicating a high maximum (e.g., at power limit or maximum allowed power) transmission power and an intelligent power allocation based on one or more link quality scores 225 of the subscribed receiver devices 112 being less than one or more link quality thresholds 255 or one or more average RSSIs 235 of the subscribed receiver devices 112 being below one or more RSSI thresholds 265. As another yet another example, tracking circuitry 106 is configured to select an updated transmission power profile 275 (e.g., high TX power profile) indicating a high (e.g., at power limit or maximum allowed power) maximum transmission power and an even power allocation based on one or more link quality scores 225 of the subscribed receiver devices 112 being less than one or more link quality thresholds 255 and one or more average RSSIs 235 of the subscribed receiver devices 112 being less than one or more RSSI thresholds 265. Though three examples of predetermined updated transmission power profiles 275 are provided from which tracking circuitry 106 may select, in other embodiments, tracking circuitry 106 is configured to select from any non-zero integer number of predetermined updated transmission power profiles 275 based on a comparison of the link quality scores 225 and average RSSIs 235 of the subscribed receiver devices 112 to one or more link quality thresholds 255, RSSI thresholds 265, or both.

After selecting a predetermined updated transmission power profile 275, at block 285, broadcast circuitry 104 broadcasts one or more packets (e.g., broadcasts one or more additional packets) of audio stream 115 based on the selected predetermined updated transmission power profile 275. For example, tracking circuitry 106 updates the transmission power profile 125 based on the selected updated transmission power profile 275 (e.g., to match the selected updated transmission power profile 275). Broadcast circuitry 104 then broadcasts one or more packets (e.g., broadcasts one or more additional packets) of audio stream 115 based on the transmission power profile 125 as updated by tracking circuitry 106.

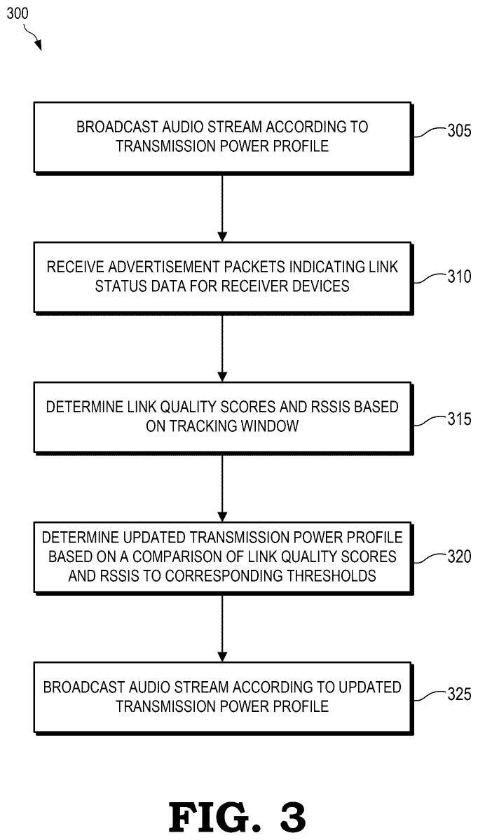

Referring now to FIG. 3, an example method 300 for adjusting a transmission power profile for a broadcast on advertisement packets from one or more receiver devices. In embodiments, example method 300 is implemented at least in part by UE 102. Example method 300 includes, at block 305, UE 102 broadcasting one or more packets of an audio stream 115 based on transmission power profile 125. For example, UE 102 broadcasts packets of audio stream 115 on one or more isochronous channels 105 at transmission powers based on transmission power profile 125. In response to broadcasting one or more packets of audio stream 115, at block 310, UE 102 is configured to periodically listen for and receive one or more broadcast advertisement packets 155 including link status data 165 from one or more receiver devices 112 receiving at least a portion of the audio stream 115. UE 102, in response to receiving a broadcast advertisement packet 155, adds data representing the receiver device 112 identified in the broadcast advertisement packet 155 (e.g., identified by a device ID in the broadcast advertisement packet 155) to the broadcast subscriber list 175. Additionally, in response to receiving a broadcast advertisement packet 155, UE 102 determines broadcast subscriber link data 185 representing a PER and RSSI of the receiver device 112 based on the link status data 165 and transmit power indicated in the broadcast advertisement packet 155.

At block 315, UE 102 is configured to determine respective link quality scores 225 and average RSSIs 235 for one or more receiver devices 112 identified in the broadcast subscriber list 175 (e.g., one or more subscribed receiver devices 112) over a tracking window 195 (e.g., over the period of time indicated by the tracking window 195) based on broadcast subscriber link data 185 (e.g., PERs, RSSIs) previously determined for the subscribed receiver devices 112, one or more received broadcast advertisement packets 155 from the subscribed receiver devices 112, or both. As an example, UE 102 determines a link quality score 225 for a subscribed receiver device 112 based on PERs indicated by broadcast advertisement packets 155 received from the subscribed receiver device 112 within the tracking window 195. As another example, UE 102 determines an average RSSI 235 (e.g., RSSI over a tracking window 195) for a subscribed receiver device 112 based on transmit powers indicated by broadcast advertisement packets 155 received from the subscribed receiver device 112 within the tracking window 195. After determining link quality scores 225 and average RSSIs 235 for one or more subscribed receiver devices 112, at block 320, UE 102 selects a predetermined updated transmission power profile 275 based on a comparison of the link quality scores 225, average RSSIs 235, or both of one or more subscribed receiver devices 112 to one or more thresholds (e.g., one or more link quality thresholds 255, RSSI thresholds 265, or both). At block 325, UE 102 then broadcasts one or more additional packets of the audio stream 115 based on the selected updated transmission power profile 275. For example, UE 102 modifies the transmission power profile 125 based on (e.g., to match) the selected updated power transmission profile 275 and then broadcasts packets of the audio stream 115 according to the modified transmission power profile 125.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A user equipment (UE), comprising
broadcast circuitry configured to broadcast a first packet of an audio stream based on a transmission power profile; and
tracking circuitry configured to:
concurrently with the broadcast circuitry broadcasting the audio stream, receive a plurality of advertisement packets, each packet of the plurality of advertisement packets including link status data for a corresponding receiver device;
determine respective link qualities between the UE and one or more receiver devices over a moving period of time based on link status data identified in the plurality of advertisement packets; and
select a predetermined updated transmission power profile based on the link qualities between the UE and the one or more receiver devices,
wherein the broadcast circuitry is configured to broadcast a second packet of the audio stream based on the selected predetermined updated transmission power profile.

2. The system of claim 1, wherein the broadcast circuitry is configured to:
broadcast the first packet of the audio stream on one or more isochronous channels of the UE based on the transmission power profile; and
broadcast the second packet of the audio stream on the one or more isochronous channels of the UE based on the selected predetermined updated transmission power profile.

3. The system of claim 1, wherein the tracking circuitry is configured to:
add data indicating each receiver device identified in the plurality of advertisement packets to a broadcast subscriber list.

4. The system of claim 1, wherein the tracking circuitry is configured to:
for each receiver device identified in the plurality of advertisement packets, determine an average packet error rate (PER) based on advertisement packets of the plurality of advertisement packets identifying the receiver device and received during the moving period of time.

5. The system of claim 4, wherein the tracking circuitry is configured to:
for each receiver device identified in the plurality of advertisement packets, determine the link quality between the receiver device and the UE based on the corresponding average PER.

6. The system of claim 5, wherein the tracking circuitry is configured to:
select the predetermined updated transmission power profile based on a comparison of the respective link qualities between the UE and the one or more receiver devices to one or more thresholds.

7. The system of claim 1, wherein the moving period of time comprises a moving five second window.

8. The system of claim 1, wherein the tracking circuitry is configured to select the predetermined updated transmission power profile further based on an average RSSI over the moving period of time for each receiver device identified in the plurality of advertisement packets.

9. The system of claim 1, wherein the transmission power profile indicates a first maximum power and a first power allocation type.

10. The system of claim 9, wherein the predetermined updated transmission power profile indicates a second maximum power different from the first maximum power and a second power allocation type different from the first power allocation type.

11. A user equipment (UE), comprising
broadcast circuitry configured to broadcast a first packet of an audio stream on one or more isochronous channels based on a transmission power profile; and
tracking circuitry configured to:
concurrently with the broadcast circuitry broadcasting the audio stream, receive a plurality of advertisement packets, each packet of the plurality of advertisement packets including link status data for a corresponding receiver device;
for each receiver device identified in the plurality of advertisement packets:
determine an average packet error rate (PER) based on advertisement packets of the plurality of advertisement packets identifying the receiver device and received during the moving period of time; and
determine the link quality between the receiver device and the UE based on the corresponding average PER; and
select a predetermined updated transmission power profile based on the link qualities between the UE and the one or more receiver devices,
wherein the broadcast circuitry is configured to broadcast a second packet of the audio stream based on the selected predetermined updated transmission power profile.
